(19) United States
(12) Patent Application Publication
(10) Pub. No.: US 2004/0249022 A1
(43) Pub. Date: Dec. 9, 2004

(54) Method for the preparation of flameproof hermoplastic resin compositions

(76) Inventor: Wen-Yi Su, Taichang (TW)

Correspondence Address: Wen-Yi Su, P.O. Box 55-124, Taichung, TW

(21) Appl. No.: 10/452,512

(22) Filed: Jun. 3, 2003

(51) Int. Cl. C08K 5/49

(52) U.S. Cl. 523/221; 524/115

(57) ABSTRACT

The present invention provides a method for the preparation of flame retardant thermoplastic resin composition, thereby to improve the feeding smoothness in the mixing process and to prepare resin composition having good anti-dripping property. The method comprises the steps of: (1) mixing 0.01-10 parts by weight of powdery fluoro-resin (A) having a particle size in the range of 60-2000 μm, 0.02-20 parts by weight of powdery thermoplastic resin (B₁) and/or powdery compound (B₂) to form a mixture; (2) blending 0.03-30 parts by weight of said mixture with 100 parts by weight of thermoplastic resin (C) and 0.1-40 parts by weight of flame retardant (D) via an extruder.

### BACKGROUND OF THE INVENTION

1. Field of the Invention

The present invention relates to a method for the preparation of flame-retardant thermoplastic resin compositions. In particular, it relates to a method which has the advantages of smooth feeding and no clog forming in the feeding port of the extruder, and the resultant resin compositions being excellent in flame resistance and anti-dripping property.

2. Background of the Invention

Flame-retardant thermoplastic resins such as flame-retardant styrenic resin, polycarbonate, polyphenylene oxide, polybutylene terephthalate (PBT) and polyethylene glycol terephthalate (PET), and the like have commonly been used as the housing material of housed hold electrical appliances, office electrical appliances, or electrical appliances for other applications where in the cpmposition of styrenic reson and polycarbonate has widely been used for the above applications due to its good toughness.

Generally flame-retardanrs such as a halogen-containing, a phosphorouse-containing or a nitrogen containing flame retardants can be used to impart the flame retardancy of the composition of styrenic resin and polycarbonate.

However, the resin composition with the above-mentioned flame retardants, when burning often fails to pass the V-O level test of UL-94 (Underwriters Laboratories U.S.A.) due to dripping. In order to prevent the dripping of the resin compositions, U.S. Pat. No. 3,005,795 discloses that fluororesin can act as an anti-dripping agent of the glass fiber reinforced resin composition. Japan Patent Laid Open No. JP-A-59-64561 discloses that the anti-dripping property of resins can be improved by adding polytetrafluoroethylene (PTFE) into the composition of polycarbonate, styrenic resin and a flame-retardant. The reason why the fluororesin improves the anti-dripping property of the resin composition is that fluororesin from a fibril structure in the resin composition compounded by an extruder. The fibril structure shrinks when heated, and it leads to the prevention of the resin compositions from dripping when burning at high temperature. Addition of small amount of fluororesin makes significant effect of anti-dripping. However, the powdery fluororesin is apt to bridging and clogging the feed port due to the formation of the fibril structure during feeding to an extruder, which results in an error of feeding ratio of the respective component, which in turn deteriorates the flame resistance leading to failing in passing the UL-94 V-O test. U.S. Pat. No. 4,810,739 and U.S. Pat. No. 5,061,745 discloses that dripping phenomenor of the resin during burning can be effectively reduced and the surface imperfection of the molded article can be eliminated by adding an aqueous dispersion of fluororesin of 60 wt % solid content into a composition of polycarbonate, styrenic resin and a flame-retardant. However, aqueous fluororesin dispersion is difficult to feed to the extruder. The pump as a feeding device tends to clog during extrusion. Furthermore, the aqueous dispersion tends to stick to and clog the feed port of the extruder and causes inaccuracy of feeding.

### SUMMARY OF THE PRESENT INVENTION

The object of the present invention is to provide a method for the preparation of flame-retardant thermoplastic resin compositions having the properties of good impact strength, good flame resistance, and good antidripping, by which method the raw material do not form clogging during feeding to an extruder.

1. A process for the preparation of flame-retardant thermoplastic resin composition, comprising the steps of:

(1) mixing 0.01-10 parts by weight of powdery fluororesin (A) with 0.02-20 parts by weight of powdery themoplastic resin (B₁) and/or powdery compound (B₂) to form a mixture, wherein said powdery fluororesin (A) has a mean particle size of 60-2000 um;

(2) blending 0.03-30 parts by weight of said mixture 100 parts by weight of thermoplastic resin (C) and 0.1-40 parts by weight of flame retardant (D) via an extruder.

By the preparation method, there is no bridging or clogging at the feed port of the extruder. The raw materials can be fed smoothly. Meanwhile, the obtained resin composition has the properties of good flame resistance and good antidripping properties.

### DETAILED DESCRIPTION OF THE PREFERRED EMBODIMENTS

The method for the preparation of flame-retardant thermoplastic resin compositions according to the present invention, the powdery fluoro-resin (A) is a fluoro-containing resin, preferably a dry resin in powdery form with a moisture content of less than 3 wt % such as polytetrafluoroethylene (PTFE). The powdery fluoro-resin (A) has an average particle size of about 60-2000 μm, preferably about 70-1000 μm. When the average particle size is larger than 60 μm, the bridging in feeding to the extruder, namely, clogging in the feed port of the extruder is substantially reduced. When the mean-particle size of the powdery fluoro-resin (A) is smaller than 2000 μm, a stable feeding rate, an uniform dispersion of the powdery fluoro-resin (A) in the resin composition, and the antidripping property of the resin compostion can be obtained. The amount of the powdery fluoro-resin (A) is 0.01-10 parts by weight, preferably 0.02-3 parts by weight, and more preferably 0.05-1 part by weight, based on 100 parts by weight of the thermoplastic resin (C). When the amount of the powdery fluoro-resin (A) is larger than 0.01 part by weight, the improvement in flame resistance is significant; when the amount is smaller than 10 parts by weight, the surface appearance of the finished product is good.

The powdery thermoplastic resin (B₁) of the present invention may be, for example, vinyl resins, polyamide, phenol-formaldehyde resins, polycarbonate, polyester and the like; wherein vinyl resin and polycarbonate are preferred. The resins can be used singly or in combination of two or more thereof. The vinyl resins can be obtained by polymeration of the following monomers: styrenic monomers, such as styrene, α-methylstyrene, p-methylstyrene, o-methylstyrene, tert-butylstyrene, o-ethylstyrene, p-chlorostyrene, o-chlorostyrene, 2,4-dichlorostyrene, p-methoxystyrene, o-methoxystyrene, 2,4-dimethylstyrene, and the like; (meth)acrylic monomers, such as methyl acrylate, methyl methacrylate, ethyl acrylate, ethyl methacrylate, butyl acrylate, butyl methacrylate, 2-ethylhexyl acrylate, 2-ethylhexy methacrylate, dodecyl acrylate, dodecyl methacrylate, tridecyl acrylate, tridecyl methacrylate, and the like; vinyl cyanide monomers, such as acrylonitrile, methacrylonitrile, and the like; α,β-unsaturated carboxylic acids, such as maleic anhydride, methacrylic acid and the like; maleimide monomers, such as N-phenyl maleimide, N-methyl maleimide, N-cyclohexyl maleimide, and the like; epoxy-containing monomers, such as glycidyl methacrylate, and the like; vinyl ether monomers, such as vinyl methyl ether, vinyl ethyl ether, and the like; vinyl carboxylate monomers, such vinyl acetate, vinyl butyrate, and the like; olefinic monomers, such as ethylene, propylene, isobutene, and the like; diene monomers, such butadiene, isoprene, dimethylbutadiene, and the like. The monomers can be used singly or in combination of two or more thereof. Among these, styrenic monomer and vinyl cyanide monomers, is preferred. The preferred vinyl resins are acrylonitrile-butadiene-styrene, styrene-acrylonitrile and polystyrene.

The powdery polycarbonate can be any of homopoly-carbonate or copolycarbonate known in the art, which can be prepared by any of the process in the art, such as by interfacial, polycondensation process, or by melt transesterification. The aforementioned process, reactants, polymers, catalysts, solvents and reaction conditions are well known in the art, and described in U.S. Pat. Nos. 2,964,974, 2,970,137, 2,999,835, 2,999,846, 3,028,365, 3,153,008, 3,287,065, 3,215,668, 3,258,414, and 5,010,162. Polycarbonate can be produced by a reaction of dihydric phenol compounds with phosgene (phosgene process). Alternatively, dihydric phenol compounds can be pre-polymerized with diphenyl carbonate monomers to produce oligomers having low molecular weight, which are then subjected to melt-polymerization (transesterification process). The particular examples of suitable dihydric phenol compounds useful in the production of polycarbonate are -bis(hydroxyaryl)-alkanes, such as bis(4-hydroxyphenyl)-methane, 1,1-bis(4-hydroxyphenyl)-ethane, 2,2-bis(4-hydroxyphenyl)butane, 1,1-bis(4-hydroxyphenyl)butane, 1,1-bis(4-hydroxyphenyl)isobutane, 2,2-bis(4-hydroxyphenyl)butane, 2,2-bis(4-hydroxy-3-methylphenyl)propane, 2,2-bis(4-hydroxy-3-butylphenyl)propane, 2,2-bis(4-hydroxy-3-cyclohexylpheyl)-propane, 2,2-bis(4-hydroxy-3-methoxy-phenyl)propane, and the like; bis-(hydroxyaryl)cycoalkane, such as 1,1-bis(4-hydroxyphenyl)cyclopentane, 1,1-bis(4-hydroxyphenyl)cyclohexane, 1,1-bis(4-hydroxyphenyl)cyclododecane, and the like; a dihydroxyaryl ethers, such as 4,4′-dihydroxyphenyl ether, 4,4′-dihydroxy-3,3′-dimethylphenyl ether, and the like; dihydroxy diaryl phosphites, such as 4,4′-dihydroxy diphenyl phosphite, 4,4′-dihydroxy-3,3′-dimethyl diphenyl phosphite, 4,4′-dihydroxy-3,3′-dimethyl diphenyl sulfite, and the like; a dihydroxy diaryl sulfide, such as 4,4′-dihydroxy diphenyl sulfide, 4,4′-dihydroxy-3,3′-dimethyl diphenyl sulfide, and the like; a dihydroxy diaryl sulfoxide, such as 4,4′-dihydroxy diphenyl sulfoxide, 4,4′-dihydroxy-3,3′-dimethyldiphenyl sulfoxide, and the like; a dihydroxydiaryl ketones, such as bis(4-hydroxyphenyl)ketone, bis(4-hydroxy-3-methylphenyl)ketone, and the like; 1,4-bis(4-hydroxyphenylsulfonyl)benzene, 4,4-bis(4-hydroxyphenylsulfonyl)-benzene, 4,4′-bis(4-hydroxyphenyl-sulfonyl)benzene, 1,2-bis(4-hydroxy-phenoxy)ethane, phenolphthalein, and so forth. The above-mentioned dihydric phenol compounds can be used singly or in combination of two or more thereof. Of these, the dihydric phenol suitable for aromatic polycarbonates of high thermo-resistance property are, for example, bis(hydroxyphenyl)alkanes, such as 2,2-bis(4-hydroxyphenyl)-propane, bis( hydroxyphenyl)cycloalkanes, such as bis(4-hydroxyphenyl)-cycohexane, and dihydroxydiphenyl sulfide, dihydroxy-diphenyl sulfoxide, dihydroxydiphenyl ketone, and so forth. The most preferred bisphenol compound is of bisphenol A type, such as 2,2′-bis(4-hydroxyphenyl)propane. The molecular weight of ploycarbonate is, for example, as a viscosity-average molecular weight measured at 20° C. by using methylene chloride, about 12,000 to 50,000, preferably about 15,000 to 40,000 and more preferably about 20,000 to 30,000.

The powdery compound (B₂) of in the present invention may be lubricant, mold release agent, flame retardant, plasticizer, tackifier, antistatic agent, antioxidant, electric conductive agent, coloring agent, filler, reinforcing agent, and flame retardant aid, etc. Examples of antioxidant of the present invention are, for example, 2,6-di-tert-butyl-4-methyl phenol, trinonylphenyl phosphite, octadecyl 3-(3,5-di-tert-butyl-4-hydroxyphenyl-propionate, thiodiethylene bis(3,5-di-tert-butyl-4-hydroxy hydrocinnamate, tetrakis[methylene(3,5-di-tert-butyl-4-hydroxy-hydrocinnamate)]methane, 2,4-bis[(octylthio)methyl]-O-cresol, tris(2,4-di-tert-butylphenyl)phosphite, dilauryl thio dipropionate, distearyl thio dipropionate, triethylene glycol-bis-3-(3-tert-butyl-4-hydroxy-5-methylphenyl) propionate, 1,1-bis(2-methyl-4-hydroxy-5-tert-butylphenyl)butane.

Examples of lubricants of the present invention are metal soap, such as calcium stearate, magnesium stearate, zinc stearate; ethylene bis stear amide (EBA), methylene bis stearyl amide, palmitic amide, butyl stearate, palmityl stearate, glycerol monostearate, n-behanic acid, stearic acid, polyethylene wax, montan wax, and the like.

The flame retardants useful in the present invention may be phosphorus-containing flame retardants, halogen-containing flame retardants and nitrogen-containing flame retardants. In the phosphorus-containing flame retardants, preferred are aromatic monophosphate and aromatic polyphosphate and the mixture thereof, wherein preferred is the aromatic polyphosphate of the following formula:

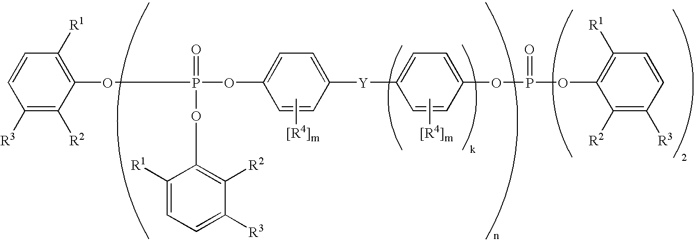

wherein, R¹, R², which may be the same or different, are alkyl; R³, R⁴ are hydrogen or lower alkyl; Y may be a single bond, —CH₂—, —C(CH₃)₂—, —S—, SO₂—, —O— or —N═N—; k is 0 or 1; m is an integer of 0-4; n is an integer of 1-5 (n may also be an average value of 0.5-4 when it is a mixture of different value of n). In the above formula where R¹, R², and R³ are lower alkyl group, which means an alkyl group of less than 4 carbon atoms, for example methyl, ethyl, 3-butyl, etc.

Examples of nitrogen-containing flame retardants may be triazine types or phosphazene types retardants.

The particular aromatic mono phosphate useful in the present invention are, for example, the follows: triphenyl phosphate, tribenzenyl phosphate, tri(dimethyl)phenyl phosphate, benzenyl diphenyl phosphate, tri(2,6-dimethylphenyl) phosphate, di(2,6-dimethyl phenyl)phenyl phosphate, and the like and the mixture thereof.

The particular examples of the halogen-containing flame retardants can be classified into six types as follows:

1. bromime-containing phosphate: for example tris(tribromoneopentyl) phosphate, and the like;

2. brominated cyclic aliphatics: for example hexabromo cyclododecane, and the like;

3. halogenated phenols: for example tetrabromo bisphenol A (TBBA), and the like;

4. derivatives of tetrabromo bisphenol A, and the like;

5. brominated epoxy oligomers: for example oligomer derived from brominated phenols and epichloro hydrin, and the like; and

6. brominated diphenyl ethers: for example decabromodiphenyl ether, and the like.

The flame retardant aids useful in the present invention are, for example, antimony trioxide (Sb₂O₃), antimony pentoxide (Sb₂O₅), and the like. The representative antistatic agents are, for example, tertiary amine compounds, quaternary ammonium salt compounds, polyamide polyether, or permanent antistatic agents, such as epichloro hydrin polymers. The representative fillers are, for example, calcium carbonate, carbon black, wollastonite, clay, mica, and the like. The representative reinforced agents are, for example, glass fiber, carbon fiber, various whiskers, and the like. The representative coloring agents are, for example, titanium oxide, iron oxide, graphite, phthalocyanine dyes, and the like.

The thermoplastic resin (B₁) and/or compound (B₂) is in powdery form. In respect to the feeding smoothness for extruder, it is preferred to use the dry powdery material with water content of less than 3 wt %. There are not particular limits to the particle size of the powdery thermoplastic resin (B₁) and/or powdery compound (B₂), any materials of (B₁) and/or (B₂) in powdery form can be used. The powdery materials preferably have particle size of less than 1500 μm, and more preferably of less than 1000 μm. When the particle size is less than 1500 μm, raw material can be fed to extruder more smoothly without clogging due to bridging.

The addition amount of the powdery thermoplastic resin (B₁) and/or powdery compound (B₂) according the present invention is 0.02-20 parts by weight, preferably 0.1-15 parts by weight, and most preferably 0.5-10 parts by weight, based on 100 parts by weight of thermoplastic resin (C). When the addition amount of the powdery thermoplastic resin (B₁) and/or powdery compound (B₂) is larger than 0.02 part by weight, the obtained resin composition exhibits good flame resistance and can be able to pass the UL-94 V-O test. When the addition amount is less than 20 parts by weight, the mixing can be processed easily without heavy load.

Furthermore, according to the present invention, the weight ratio of powdery fluoro resin (A) to powdery thermoplastic resin (B₁) and/or powdery compound (B₂), i.e., (A)/(B₁)+(B₂) is preferably 0.05-20 wt %/80-99.95%, and more preferably 0.05-10 wt %/90-99.5 wt %. When the ratio (A)/(B₁)+(B₂) is in the range of 0.05-20 wt %/80-99.95 wt %, raw material can be fed to extruder more smoothly without clogging due to bridging, the obtained resin composition exhibits good flame resistance, and can be able to pass the UL-94 V-O test. The flame-retardant thermoplastic resin composition according to the present invention can be prepared by mixing (A) with (B₁) and/or (B₂) in the above-mentioned range of ratio by means of a Hanscher mixer, followed by blending 0.03-30 parts by weight of the above-obtained mixture with 100 parts by weight of thermoplastic resin (C) and 0.1-40 parts by weight of flame retardant via an extruder.

The thermoplastic resin (C) of the present invention, which composition may be the same or different from the powdery thermoplastic resin (B₁), may be in the form of particulate or powder without particular limit. For the purpose of the present invention, the preferred thermoplastic resin (C) is styrenic resin and/or polycarbonate. Examples of the styrenic resin are rubber-modified styrenic resin, such as styrene-butadiene-acrylonitrile copolymer polystyrene and styrene-acrylonitrile copolymer.

The polycarbonate of the present invention, which composition may be the same as the polycarbonte described above in the powdery thermoplastic resin (B₁), may be in the form of particulate, etc., without particular limit.

The flame retardant (D) of the present invention which composition may be the same or different from the flame retardant described in the powdery compound (B₂), may be in powdery form or particulate form. The amount of the flame retardant (D) is 0.1-40 parts by weight, based on 100 parts by weight of thermoplastic resin (C). When the amount is higher than 0.1 part by weight, the resultant resin composition exhibits good flameproof property.

Flame retardant aids such as antimony trioxide, antimony pentoxide, UV absorbent, UV stabilizer, anti-static agent, fillers, reinforcing agent, coloring agent, heat stabilizer, heat discoloration inhibitor, coupling agent, and other additives can be optionally added into the resin composition of the present invention.

In a specific example of the present invention, the powdery fluoro-resin (A) and powdery thermoplastic resin (B₁) and/or powdery compound (B₂) are mixed to form a mixture at first. Then, the mixture is fed to an extruder by means of a screw feeder along with the thermoplastic resin (C) and flame retardant (D) which are fed to the same extruder by means of another screw feeder. The two feeders are operated in accordance with a predetermined ratio of the feeds.

Generally, the method used for mixing the powdery fluoro-resin (A) with the powdery thermoplastic resin (B₁) and/or powdery compound (B₂) is not particularly limited. Any methods which can make the powdery fluoro-resin (A) uniformly dispersed in the mixture can be used. Mixing devices which can be used in the process are, for example, high speed stirring mixers such as Hanscher mixer and micro speed mixer, or conventional mixers such as tumble mixer, V type blender, double cone mixer, ribbon mixer, and the like. In respect of better mixing and dispersing, high speed stirring mixer is preferable. Extrusion devices used in the present invention are not particularly limited. Use can be made of, for example, single screw extruder or twin screw extruder equipped with one or more vents optionally, suitable degassing aid can be added to the extruder to remove any residual solvent or other volatile components. Generally, the barrel of the extruder is set at a temperature of 180-360° C., to produce the flame-retardant resin compositions of the present invention.

### CRITERIA FOR PHYSICAL PROPERTIES TEST

1. Impact Strength (IZOD, kg-cm/cm): measured in accordance with ASTM D-256 (⅛ inch test specimens),

2. Flame Resistance: measured in accordance with the Vertical Burning Test (UL-94, V-O) Procedure set up by Underwriter Laboratory, USA. The test specimens used are 1/16 inch in thickness. By V-O it means that there is no dripping during the test and the burning time (express in seconds) is in accordance with the demanded V-O standards. The test result is marked as V-2, if there is flame dripping during the test and the burning time is in accordance with the demanded V-2 standards, and

3. Inspection of clog formation in extruder feed inlet:

O: smooth feeding, without clog formation.

X: bridging occurrence leading to clog in feeding.

### PREPARATION EXAMPLES

Type and specification of raw materials used in the following examples and comparative examples in the present invention are as follows:

(A-1): powdery polytetrafluoroethylene: TEFLON-GCJ (DuPont, mean particle size of less than 500 μm), hereinafter abbreviated as powdery PTFE.

(A-2): emulsion polytetrafluoroethylene: mean particle size of less than 50 μm, hereinafter abbreviated as emulsive PTFE (DuPont 03J).

(B₁-1): powdery polycarbonate resin: Iupilon S-2000F (Mitsubishi Chemicals, mean particle size 1,000 μm), hereinafter abbreviated as powdery PC.

(B₁₂-2): powdery styrene-acrylonitrile resin: KIBISAN PN-117 (Chi Mei Co., been pulverized to particle size of less than 1,000 μm), hereinafter abbreviated as powdery AS.

(B₁₃-3): particulate styrene-acrylonitrile resin: KIBISAN PN-117 (Chi Mei Co., with the shape of pellet having particle size of larger than 3 mm), hereinafter abbreviated as pelletized AS.

(B₁-4): powdery polystyrenic resin: Polyrex PG-33 (Chi Mei Co., been pulverized to particle size of less than 1,000 μm), hereinafter abbreviated as powdery PS.

(B₁-5): particulate styrenic resin: Polyrex PG-33 (Chi Mei Co., with the shape of pellet having particle size of larger than 3 mm), hereinafter abbreviated as pelletized PS.

(B₂-1): powdery titanium oxide, R-103 (Du Pont, particle size of less than 500 μm), hereinafter abbreviated as powdery TiO₂.

(B₂-2): powdery ethylene bis-stearamide: having particle size of less than 1,000 μm, hereinafter abbreviated as powdery EBA.

(C-1): polycarbonate resin: pellet, Iupilon S-3000 (Mitsubishi Chemicals, with the shape of pellet having particle size of larger than 3 mm), hereinafter abbreviated as PC pellet.

(C-2): styrene-butadiene-acrylonitrile pellet: Polylac PA-709M (Chi Mei Co., with the sahpe of pellet having particle size of larger than 3 mm), hereinafter abbreviated as ABS pellet.

(C-3): rubber-modified polystyrenic resin pellet: Polyrex PH-888 (Chi Mei Co., with the sahpe of pellet having particle size of larger than 3 mm), hereinafter abbreviated as HIPS pellet.

(D-1): tetrabromo biphenol A (flame retardant): hereinafter abbreviated as TBBA.

(D-2): triphenyl phosphate (flame retardant): from Great Lake Chemicals, hereinafter abbreviated as TPP.

(D-3): aromatic polyphosphate (flame retardant): from Haitachi Chemical Industry Co. Ltd., with trade name of CR-741, hereinafter abbreviated as BPDP, represented by the following formula:

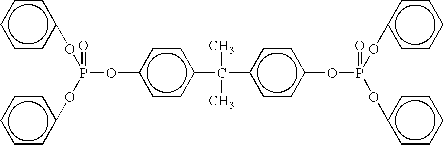

Antimony trioxide (Sb203): having mean particle size of 0.5-1.0 μm.

### EXAMPLES

### Example 1

0.3 part by weight of powdery PTFE resin having mean particle size of 500 μm (A-1) was mixed with 3.45 parts by weight of powdery PC having particle size of less than 1,000 μm (B₁-1) in a mixer, the resultant mixture was then fed by a loss-in-weight type screw feeder to an extruder. Separately, 100 parts by weight of PC pellet (C-1) were mixed with 8 parts by weight of TPP flame retardant (D-2) in another mixer, the resultant mixture was then fed to the inlet of the extruder by another loss-in-weight type screw feeder. These two feeders were operated in accordance with pre-determined feed rates. The extruder was a twin screw extruder equipped with several vents, and the temperature of the barrel of the extruder was controlled at 210-240° C. (W&PZSK-25, made in Germany), whereby the mixtures were extruded to produce the flame retardant thermoplastic resin composition. The evaluation results were shown in Table 1

### Example 2

The procedure in Example 1 was repeated, except that 8 parts by weight of TPP (D-2) was replaced by 8 parts by weight of BPDP (D-3). The evaluation results were shown in Table 1.

### Example 3

The procedure in Example 1 was repeated, except that powdery PC (B₁-1) was replaced by powdery AS (B₁-2) and changes of thermoplastic resin (C) and flame retardant (D) were shown in Table 1. The evaluation results were shown in Table 1.

### Example 4

The procedure in Example 1 was repeated, except that the amount of powdery PTFE (A-1) was changed from 0.3 part by weight to 1.0 part by weight, the amount of powdery PC (B₁-1) was changed from 3.45 parts by weight to 11.5 parts by weight and flame retardant (D) was 10 parts by weight of BPDP (D-3). The evaluation results were shown in Table 1.

### Example 5

The procedure in Example 1 was repeated, except that the amount of powdery PTFE (A-1) was changed from 0.3 part by weight to 0.5 part by weight, the amount of powdery PC (B₁-1) was changed from 3.45 parts by weight to 5.75 parts by weight and flame retardant (D) was 10 parts by weight of aromatic polyphosphate. The evaluation results were shown in Table 1.

### Example 6

The procedure in Example 1 was repeated, except that the amount of powdery PC (B₁-1) was changed from 3.45 parts by weight to 5.7 parts by weight and flame retardant (D) was 8 parts by weight of BPDP (D-3) were used as the flame retardant. The evaluation results were shown in Table 1.

### Example 7

The procedure in Example 1 was repeated, except that 3.45 parts by weight of powdery PC (B₁-1) was replaced by 3.45 parts by weight of powdery PS (B₁-4) and thermoplastic resin (C) was 100 parts by weight of HIPS pellet (C-3) and flame retardant (D) was 20 parts by weight of TBBA (D-1) in combination with 7 parts by weight of antimony trioxide. The evaluation results were shown in Table 1.

### Example 8

The procedure in Example 1 was repeated, except that 3.45 parts by weight of powdery PC (B₁-1) was replaced by 3.45 parts by weight of powdery AS (B₁-2) and changes of thermoplastic resin (C) flame retardant (D) and antimony trioxide were shown in Table 1. The evaluation results were shown in Table 1.

### Example 9

The procedure in Example 1 was repeated, except that 3.45 parts by weight of powdery PC (B₁-1) was replaced by 2.45 parts by weight of powdery AS (B₁-2) and 1.0 parts by weight of powdery EBA (B₂-2). The evaluation results were shown in Table 1.

### Example 10

The procedure in Example 1 was repeated, except that 3.45 parts by weight of powdery PC (B₁-1) was replaced by 2.7 parts by weight of powdery TiO₂ (B₂-1), and changes of thermoplastic resin (C) and flame retardant (D) were shown in Table 1. The evaluation results were shown in Table 1.

### Example 11

The procedure in Example 1 was repeated, except that 3.45 parts by weight of powdery PC (B₁-1) was replaced by 5.7 parts by weight of powdery AS (B₁-2), and changes of thermoplastic resin (C) and flame retardant (D) were shown in Table 1.

### COMPARATIVE EXAMPLES

### Comparative Example 1

The procedure in Example 1 was repeated, except that powdery PC (B₁-1) was not used. The evaluation results were shown in Table 1.

### Comparative Example 2

The procedure in Example 2 was repeated, except that powdery PC (B₁-1) was not used. The evaluation results were shown in Table 1.

### Comparative Example 3

The procedure in Example 3 was repeated, except that powdery AS (B₁-2) was not used. The evaluation results were shown in Table 1.

### Comparative Example 4

The procedure in Example 3 was repeated, except that 3.45 parts by weight of powdery AS (B₁-2) was replaced by 3.45 parts by weight of palletized AS (B₁-3). The evaluation results were shown in Table 1.

### Comparative Example 5

The procedure in Example 7 was repeated, except that 3.45 parts by weight of powdery PS (B₁-4) was replaced by 3.45 parts by weight of palletized PS (B₁-5). The evaluation results were shown in Table 1.

### Comparative Example 6

The procedure in Example 8 was repeated, except that 3.45 parts by weight of powdery AS (B₁-2) was replaced by 3.45 parts by weight of pelletized AS (B₁-3). The evaluation results were shown in Table 1.

### Comparative Example 7

The procedure in Example 1 was repeated, except that 3.45 parts by weight of powdery PC (B₁-1) and 0.3 parts by weight of powdery PTFE (A-1) were not used, and 0.3 part by weight of emulsion PTFE (A-2) was directly fed into the inlet of the extruder. The evaluation results were shown in Table 1.

### Comparative Example 8

0.3 part by weight of powdery PTFE (A-1), 3.45 parts by weight of powdery PC (B₁-1) and 100 parts by weight of PC pellet (C-1) were mixed with 8 parts by weight of TPP (D-2) in a mixer, the resultant mixture was then fed by a loss-in-weight screw feeder to a twin screw extruder equipped with several vents. The temperature of the barrel of the extruder was controlled at 210-240° C. (W&PZSK-25, made in Germany), whereby the mixtures were extruded to produce a flame retardant thermoplastic resin composition. The evaluation results were shown in Table 1.

### Comparative Example 9

0.3 part by weight of powdery PTFE (A-1) and 100 parts by weight of PC pellet (C-1) were mixed in a mixer, the resultant mixture was fed by a weight screw feeder to an extruder. Separately, 3.45 parts by weight of powdery PC (B₁-1) was mixed with 8 parts by weight of TPP (D-2) in another mixer. The resultant mixture was then fed to the above-mentioned extruder. These two feeders were operated in accordance with pre-determined feed rates. The extruder was a twin screw extruder equipped with several vents, and the temperature of the barrel of the extruder was controlled at 210-240° C. (W&PZSK-25, made in Germany), The mixtures were extruded to produce a flame reatrdant thermoplastic resin composition. The evaluation results were shown in Table 1.

It can be found from comparative examples 1-3 that, in the extrusion process of the flame reatrdant thermoplastic resin composition of the present invention, when fluoro-resin (A) is used singly without prior mixing with powdery thermoplastic resin (B₁) and/or powdery compound (B₂), the resultant resin composition tends to exhibit dripping in the UL-94 vertical burning test and fails to comply with V-O level. It is revealed from comparative examples 4-6 that when pellet thermoplastic resin (B₁) is used in place of powdery thermoplastic resin (B₁), feeding of the raw materials to the inlet of the extruder can not be smoothly operated and clogging occures in the inlet. Further, the resultant resin composition tends to exhibit dripping in the vertical burning test and fails to comply with UL-94 V-O level. Comparative example 7 shows that, when the emulsion PTFE (A-2) is used, clogging tends to form in the inlet of extruder during feeding to the extruder. In comparative examples 8 and 9, changes in the feeding sequence of components (A), (B), (C), and (D) results in that feeding to the inlet of extruder can not be smoothly operated and clogging occures in the inlet of the extruder. The resultant resin composition tends to exhibit dripping in the vertical burning test and fails to comply with UL-94 V-O level.

In contrast, when operated under the conditions disclosed in the scope of the present invention, the process of the present invention not only possesses the advantages of smooth feeding and no clog forming, but also can produce the flame retardant thermoplastic resin composition excellent in flame resistance property.

While particular examples of the present invention have been described, it would be obvious to those skilled in the art that various changes and modifications to the contents disclosed herein can be made without departing from the spirit and scope of the invention. It is intended to cover, in the appended claims, all such modifications that are within the scope of this invention.

What we claimed are:

1. A process for the preparation of flame retardant thermoplastic resin composition, comprising the steps of:
(1) mixing 0.01-10 parts by weight of powdery fluoro-resin (A) with 0.02-20 parts by weight of powdery thermoplastic resin (B₁) and/or powdery compound (B₂) to form a mixture, wherein said powdery fluoro-resin (A) has a mean particle size of 60-2000 μm;
(2) blending 0.03-30 parts by weight of said mixture with 100 parts by weight of thermoplastic resin (C) and 0.1-40 parts by weight of flame retardant (D) via an extruder.

2. The process for the preparation of flame retardant thermoplastic resin composition according to claim 1, wherein the powdery thermoplastic resin (B₁) and/or powdery compound (B₂) have a particle size of less than 1500 μm.

3. 3. The process for the preparation of flame retardant thermoplastic resin composition according to claim 2, wherein the powdery thermoplastic resin (B₁) and/or powdery compound (B₂) have a particle size of less than 100 μM.

4. The process for the preparation of flame retardant thermoplastic resin composition according to claim 1, wherein the powdery fluoro-resin (A) has a mean particle size of 70-1000 μm.

5. The process for the preparation of flame retardant thermoplastic resin composition according to claim 1, wherein the weight ratio of the powdery fluoro-reisn (A) to the powdery thermoplastic resin (B₁) and/or the powdery compound (B₂), namely, (A)/(B₁)+(B₂) is in the range of 0.05-20 wt %/80-99.95 wt %.

6. The process for the preparation of flame retardant thermoplastic resin composition according to claim 5, wherein the weight ratio of the powdery fluoro-reisn (A) to the powdery thermoplastic resin (B₁) and/or the powdery compound (B₂), namely, (A)/(B₁)+(B₂) is in the range of 0.05-10 wt %/90-99.95 wt %.

7. The process for the preparation of flame retardant thermoplastic resin composition according to claim 1, wherein said flame retardant (D) is halogen-containing flame retardant and/or phosphorus-containing flame retardant.

8. The process for the preparation of flame retardant thermoplastic resin composition according to claim 1, wherein said powdery compound (B₂) is selected from the group consisting of mold release agent, flame retardant, plasticizer, tackifier, antistatic agent, antioxidant, electric conductive agent, coloring agent, filler, flame retardant aid, lubricant, reinforcing agent.
